(19) United States
(12) Patent Application Publication
(10) Pub. No.: US 2014/0289656 A1
(43) Pub. Date: Sep. 25, 2014

(54) Systems and Methods for Creating and Using Electronic Content with Displayed Objects Having Enhanced Features

(71) Applicants: Rebecca Sun, San Francisco, CA (US); Jeffrey Kamerer, Columbus, OH (US); Peter W. Moody, Plano, TX (US)

(72) Inventors: Rebecca Sun, San Francisco, CA (US); Jeffrey Kamerer, Columbus, OH (US); Peter W. Moody, Plano, TX (US)

(21) Appl. No.: 12/572,867

(22) Filed: Oct. 2, 2009

(51) Int. Cl. G06F 3/048

(52) U.S. Cl. 715/765; 715/780

(57) ABSTRACT

Systems and methods create and use electronic content that provides objects with capabilities extended beyond those provided by traditional infrastructures. For example, if a tag-based infrastructure does not allow creating an object prior to the object being displayed, a content creator or other user may be able to define or customize a new object using script so that the new object can be created prior to being displayed. The new object may be implemented to take advantage of or otherwise use features of the tag-based infrastructure so that the new object otherwise behaves according to that infrastructure. Certain embodiments facilitate the use of objects prior to their display in environments where such use has previously been restricted or difficult. Generally, a content creation application can provide a content creator greater freedom to create, use, and parameterize objects, and/or in defining object interrelationships.

### FIELD

This disclosure generally relates to computer software that creates, edits, runs, displays, provides, or otherwise uses electronic content.

### BACKGROUND

Various content creation applications are used to create web pages, rich Internet applications (RIA), and other types of electronic content. Content creation applications typically allow a content creator to define or otherwise create content using a canvas, stage, or other editing area in which the editing area looks like the content being created will display when played. Such environments have been referred to as What You See Is What You Get or “WYSIWYG”. Where content is being developed to include interactivity, animation, movement, or other time-based activity, an editing area may display a particular instance, time, or state, such as a starting state. Generally, an editing area can be used by a content creator to create the visual appearance of objects that are used in electronic content. The content creation application takes information from the editing area and generates a piece of content that is distributed or otherwise made available for playing on computing and other electronic devices.

Content creation can also involve a content creator using text, such as tags or script, to specify the appearance and/or the functionality of objects used in content being created. Existing editing environments may maintain or create text that defines a visual appearance being created on an editing portion of a user interface. For example, a rectangle may be positioned at a certain x,y position on an editing area and a content creation application may maintain text that corresponds to this, e.g., a tag that specifies the x,y position of the rectangle. Some content creation applications allow a content creator to edit either an editing area or text reflective of that editing area to develop electronic content. Thus, a content creator may use a text editor (or other form of interface component) to change the text of a tag to specify a new x,y position for the rectangle of the prior example. Or, the content creator may simply reposition the rectangle on the editing area. Text may also be used to define the functionality, movement, behavior and other aspects of objects used in content being developed. Certain content creation applications provide simple tag-based mechanisms for using objects. For example, tags may be used to define in which frame of a multi-frame content a particular object will be created, in which frame it will be moved to a new position, and in which frame it will be removed. Tags may be used to create an object having a particular object type.

Pieces of electronic content are compiled or otherwise provided from content creation applications for use on other computer devices and applications, collectively referred to herein as “content players.” For example, when information about content that is being created is collected from an editing area, text such as tags or script, and provided as a piece of content, the resulting content may be compiled or otherwise translated into a format that a content player can use to play the content. In some circumstances, a piece of content that is created maintains the original tags and/or scripts that were used in the content creation application. A player can then interpret those tags and/or scripts and, as an example, reference a library to implement the display and use of the objects as specified in the playing piece of content. An object type definition may be provided in a library that is used in both the content creation application and by the content player.

When developing content using tag-based instructions, a content creator can be constrained by limitations with respect to how tags can be used. For example, a content creation application may provide an animation that involves objects appearing sequentially in the content. The content player may interpret tags such that an object is only created if it is displayed and such that, once an object is no longer displayed, information about the object is destroyed. This limited lifecycle of such objects may hinder or prevent a content creator from defining interaction or relationships between sequentially displayed objects. As a specific example, a content creator may wish to have text that flows between sequentially displayed text block objects. However, if the objects are not available simultaneously, such linking or interrelation may be impossible or unnecessarily difficult.

### SUMMARY

Systems and methods are disclosed that create and use electronic content that relies on a basic infrastructure to interpret and display objects. Objects with capabilities beyond those provided by the basic infrastructure are included in the electronic content and used by the content players. For example, if a tag-based infrastructure does not allow creating an object prior to the object being displayed, a new object type may be defined using script so that, during content play, a new object can be created prior to being displayed. The new object may be implemented to take advantage of or otherwise use features of the tag-based infrastructure so that the new object otherwise behaves according to that infrastructure. Certain embodiments facilitate the use of objects prior to their display in environments where such use has previously been restricted or difficult. Generally, a content creation application can provide greater freedom to create, use, and parameterize objects, and/or greater flexibility in defining object interrelationships. Embodiments further facilitate and expand the use of script-based objects in combination with tag-based objects implemented according to a tag-based infrastructure to create and play electronic content.

One exemplary embodiment comprises a method of playing electronic content that involves receiving one or more files having a piece of electronic content for playing on an electronic device. Information about a first object is interpreted to display the first object. Such information may, for example, call a first create function to create the first object as an instance of a first object type and a first remove function to remove the first object. The first create function and first remove function may be generic functions applicable to any instances of a plurality of object types that all operate according to a basic framework or infrastructure. In this example, such an infrastructure is limited such that creation of object instances does not occur without display of an object, and instances (and thus, information about created objects) do not persist after their display ends. However, the exemplary method also displays an object that is an instance of an object type that is not restricted by this infrastructure. Specifically, the method involves interpreting information about a second object to display a second object, the information about the second object specifying the creation and removal of the second object as an instance of a second object type. The second object is created prior to being displayed and persists after being removed.

These exemplary embodiments are mentioned not to limit or define the disclosure, but to provide examples of embodiments to aid understanding thereof. Embodiments are discussed in the Detailed Description, and further description is provided there. Advantages offered by the various embodiments may be further understood by examining this specification.

### BRIEF DESCRIPTION OF THE FIGURES

These and other features, aspects, and advantages of the present disclosure are better understood when the following Detailed Description is read with reference to the accompanying drawings, wherein:

FIG. 1 is a system diagram illustrating an exemplary computing environment;

FIG. 2 is an illustration of a user interface of an exemplary content creation software application according to certain embodiments;

FIGS. 3A-C are screen shots of a user interface of another exemplary content creation software application in which created content has objects utilizing enhanced object features;

FIG. 4 is a flow chart illustrating an exemplary method of playing electronic content that includes objects requiring enhanced object features; and

FIG. 5 is a flow chart further illustrating the exemplary method playing electronic content that includes objects requiring enhanced object features of FIG. 4.

### DETAILED DESCRIPTION

Electronic content can include objects with capabilities that go beyond those provided by the infrastructure used to interpret and play those objects. Generally, a content creation application can provide different types of preconfigured object types for a content creator to use in electronic content. The content creator may create instances of these object types, for example, creating a first object of a rectangle type and a second object of a text type. These objects are created when included in a finalized or published piece of content and use information about the object types. In the above example, a piece of content that includes the first object and second object would identify the respective types of those objects and may include information or code about how objects of that type are to appear and function in the playing content. For example, a rectangle object type may have appearance characteristics that are specified by one or more tags and/or scripts. When the first object is included in content, attributes of the first object (e.g., its x,y location, size, color) may be specified by the content creator and also reflected in tags and/or script. When the content is provided or published, the object type's tags and/or script and the first object's tags and/or script may be included for use by the content player in displaying the first object.

A content player may interpret certain tags in a consistent way for all objects. For example, a “place object” tag may be interpreted the same way regardless of the object type. As an example, a “place object” tag may always display the object in the frame in which the tag is encountered regardless of the object type. The content player may have no way of creating an object without displaying it, if it is limited to relying on the “place object” tag as the only way of placing objects of any of the object types. Similarly, a “remove object” tag may always remove an object from the display and destroy the data about the object.

To extend the capabilities of objects beyond those provided by such a limited infrastructure, embodiments provide enhanced object types that allow object type creators to specify attributes of the objects that are otherwise limited. An object type creator may create, for example in the context of the above “place object” example, frame specific adding functionality to create an object without displaying it. To facilitate creation and use of object types that have capabilities beyond those of other object types limited by the content player infrastructure, a new or enhanced library may be provided to the content player and accessed for displaying and/or using objects of the extended object types.

For example, a content player may receive electronic content that includes both basic and enhanced object types. If a piece of content comprises a first object of a basic object type and a second object of an extended object type, the content player may interpret tags to display the first object (e.g., its creation, movement, removal etc.) according to the player's tag-based object infrastructure, such that the first object is not (and cannot be) created prior to being displayed and does not (and cannot) persist after being removed. On the other hand, the content player may interpret script to display the second object such that the second object is created prior to being displayed and/or persists after being removed. Information about the second object type may be provided in a new or expanded library that the content player uses to interpret and display electronic content.

These illustrative examples are given to introduce the reader to the general subject matter discussed herein and are not intended to limit the scope of the disclosed concepts. The following sections describe various additional embodiments and examples.

### Illustrative Computing Environment

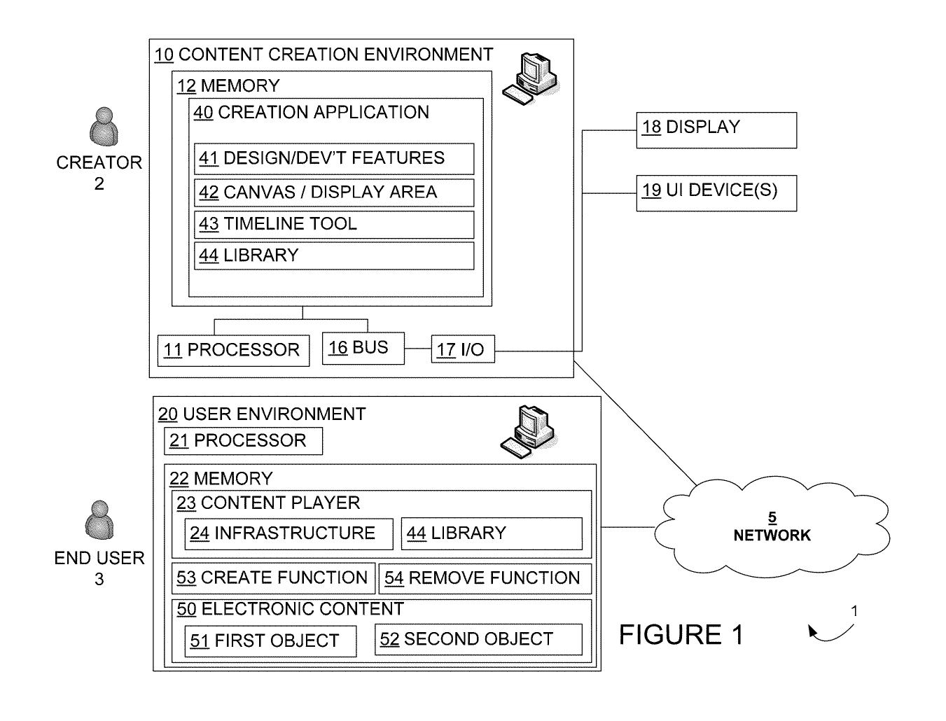

Referring now to the drawings in which like numerals indicate like elements throughout the several Figures, FIG. 1 is a system diagram illustrating an exemplary computing environment. Other computing environments may be also be used. The environment 1 shown in FIG. 1 comprises a wired or wireless network 5 connecting various network devices 10, 20. Exemplary applications that execute on each of the devices 10, 20 are shown as functional or storage components residing in memory 12, 22 on the respective devices. The memory 12, 22 may be transient or persistent. As is known to one of skill in the art, such applications may be resident in any suitable computer-readable medium and execute on any suitable processor. For example, the network devices 10, 20 shown each may comprise a computer-readable medium such as a random access memory (RAM) 12, 22 coupled to a processor 11, 21 that executes computer-executable program instructions and/or accesses information stored in memory 12, 22. Such processors may comprise a microprocessor, an ASIC, a state machine, or other processor, and can be any of a number of computer processors. Such processors comprise, or may be in communication with a computer-readable medium which stores instructions that, when executed by the processor, cause the processor to perform the steps described herein.

A computer-readable medium may comprise, but is not limited to, an electronic, optical, magnetic, or other storage device capable of providing a processor with computer-readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. The instructions may comprise processor-specific instructions generated by a compiler and/or an interpreter from code written in any suitable computer-programming language, including, for example, C, C++, C#, Visual Basic, Java, Python, Perl, JavaScript, and ActionScript.

The network 5 shown comprises the Internet. In other embodiments, other networks, intranets, combinations of networks, or no network may be used. The devices 10, 20 can be connected to a network 5 as shown. Alternative configurations are of course possible. The devices 10, 20 may also comprise a number of external or internal devices such as a mouse, a CD-ROM, DVD, a keyboard, a display, audio speakers, or other input or output devices. For example, content creation environment 10 includes a display 18 and various user interface devices 19. A bus, such as bus 16, will typically be included in each of the computing devices 10, 20.

Content creation environment 10 includes a content creation application 40 for a creator 2 to create and edit electronic content. The creation application 40 may include various design and development features 41, a canvas or editing area 42, a timeline tool 43, and a library 44. A creator 2 may position various graphically-displayed objects on the canvas or editing area 42 to specify the appearance of the application or other content that is being created. The design and development features 41 may be used to edit and configure these graphically-displayed objects and to add functionality, animation, and event-based interactivity to those objects. The timeline tool 43 may be used to further develop time aspects of content being developed including the functionality, animation, and event-based interactivity, and may allow a creator to work with one or more frames at various times along a timeline to create and edit such features. As one example, an animation may be imported and automatically (or based on creator interactions) associated with a timeline. Certain images of the animation can, for example, be associated with certain frames of the timeline. The library 44 may include classes and other code that a creator can reference or call while creating content. The library 44 may include object type definitions that are used while interpreting tags or script provided by the creator to specify content. An object type may thus be defined by tags and/or script that is used to implement instances of the object type.

The content creation environment 10 can generally be used to create electronic content that is provided for use by end users, for example, on content player 23 of user environment 20. The content player 23 may include an infrastructure 24 for interpreting basic electronic content. For example, it may include functions or other features that are applicable to most or all object types. As one specific example, the infrastructure 24 may provide a common mechanism for moving a first object 51, regardless of its object type, to a new display location based on a received move command in a piece of electronic content 50. The content player 23 may be enhanced to enable it to also use objects in ways that are not limited by the constraints of infrastructure 24. Such an enhancement may be facilitated by a new or modified library 44 provided or otherwise a part of the content player 23. In this example the library 44 on the content creation application 40 and the content player 23 are copies of the same library 44. A second object 52 may require enhanced features and thus content player 23 may access the library to implement such features during the play of the electronic content 50.

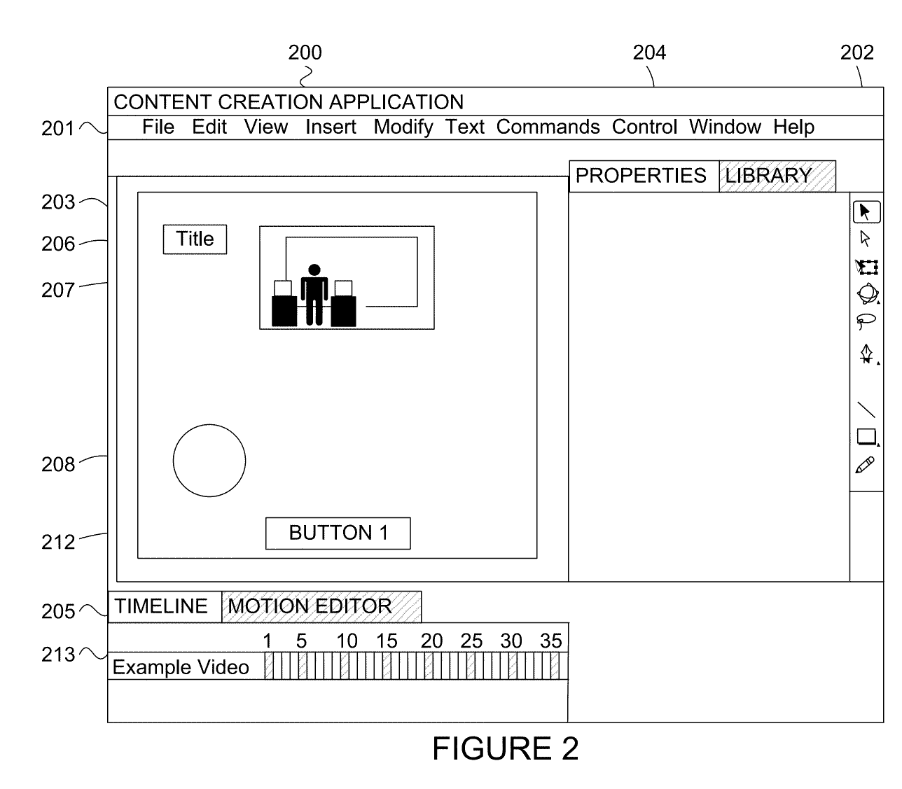

FIG. 2 is an illustration of a user interface of an exemplary content creation software application according to certain embodiments. The user interface 200 includes a basic menu 201, an editing menu 202, an editing canvas 203, a properties area 204, and a timeline area 205. The canvas displays a title object 206, a video object 207, an animated circle object 208, and a button object 212. In this example, the editing menu 202 includes various selection, text, and drawing tools that a content creator can use to add and edit objects on the canvas 203. Generally, a content creation environment may include various menus of tools or other features for editing the content, e.g., to fill in the color of a region, draw a line, and add functionality, animation, and event-based activity in such a menu or otherwise. The timeline 213 displays information about frames that can be used to define functionality, animation, and event-based activity. Generally, the user interface 200 of a content creation application can provide a creator a significant amount of flexibility with respect to using timelines and frames within content being developed. A user interface 200 may allow creator control of any frame of any timeline associated with a piece of content being developed.

Embodiments may also involve one or more other computing devices and/or applications used to create or enhance content creation application 40, for example, by providing additional or improved object types in library 44. Object types created for library 44 may be created in a content creation application 40 or in any other suitable application. In certain embodiments, object types are defined by tags and/or script. Adding new object types and improving object types in library 40 can enhance the content creation application 40 by making it more powerful, more efficient, easier to use, and/or in numerous other ways.

These exemplary devices and computing environments and exemplary uses are provided merely to illustrate various potential configurations that can be used to implement certain embodiments. Other configurations and computing environments may of course be used.

### Exemplary Methods of Creating Electronic Content

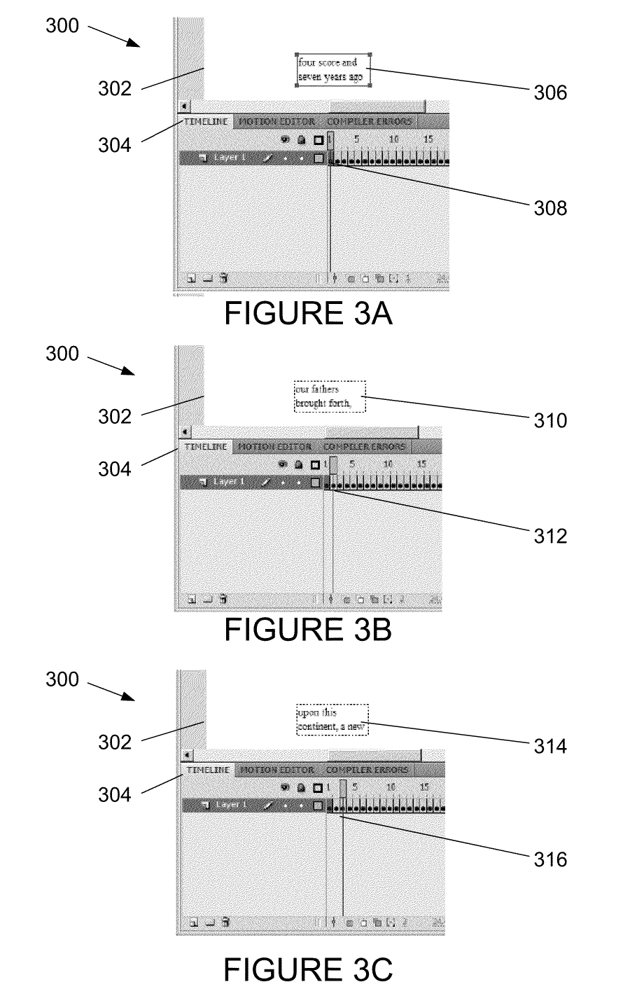

FIGS. 3A-C are screen shots of a part of a user interface 300 of another exemplary content creation software application in which created content has objects utilizing enhanced object features. In FIG. 3A, a portion of the user interface 300 shows an editing area 302 and a timeline tool 304. A first text box object 306 in the editing area 302 includes the text “four score and seven years ago.” The timeline tool 304 indicates that this view represents the first frame 308. In FIG. 3B, there is a second text box object 310 in the editing area 302 that includes the text “our fathers brought forth,” and the timeline tool 304 indicates that this view represents the second frame 312 of the content. In FIG. 3C, there is a third text box object 314 in the editing area 302 that includes the text “upon this continent, a new,” and the timeline tool 304 indicates that this view represents the third frame 316 of the content. The text of the first text box object 306, second text box object 310, and third text box object 316 may come from a single text string. Using such a single text string may be facilitated if the content creator is able to use functions or other features in which the different text box objects 306, 310, 314 can interact. For example, the portion of the text string that is shown in the second text box object 310 may depend on the size of the first text box object 312.

Implementing this type of exemplary text feature may require that text objects can be created even when they are not displayed and can be persisted even after they are no longer displayed. If an object infrastructure used by a content player does not allow such features, an enhanced object type according to the techniques provided herein can be used to provide a new object type that is not restricted by the basic object infrastructure. The new object type may include or reference script or other instructions that replace those normally provided by the basic object infrastructure. For example, a library of enhanced features may be provided for access by a content player so that the content player can display objects and use the features that are outside of the limits of the basic object infrastructure.

### Exemplary Methods of Playing Electronic Content

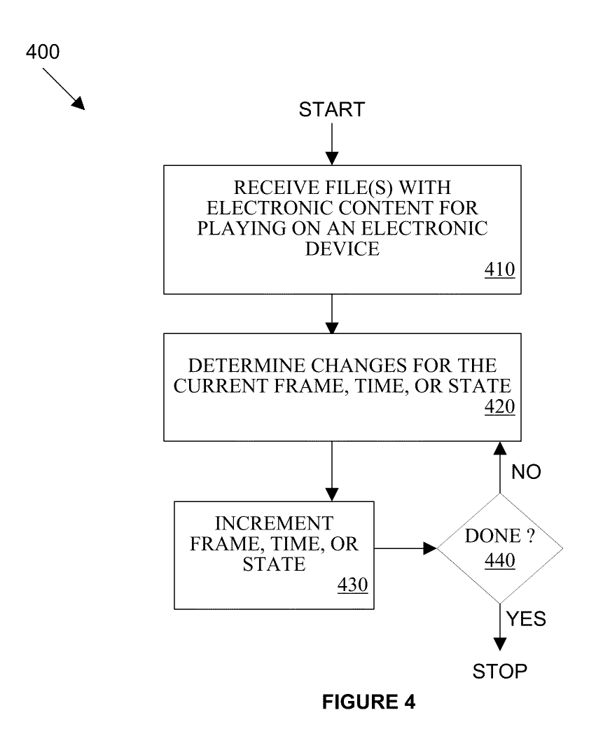

FIG. 4 is a flow chart illustrating an exemplary method 400 of playing electronic content that includes objects requiring enhanced object features. Method 400 can be performed in a variety of computing environments. The method 400 involves receiving a file or files comprising electronic content for playing on an electronic device, as shown in block 410. The electronic device could be a computer, mobile device, or any other suitable electronic device and will generally comprise a processor for processing instructions provided in the one or more files.

The exemplary method 400 involves determining changes for the current frame, time, or state of the electronic content, as shown in block 420. In the first frame or time instance, this may involve determining the initial positions of objects, initial values of variables, and performing any other functions specified for the opening of a piece of electronic content, as examples. On subsequent frames this may involve moving or changing displayed objects, creating new objects, newly displaying objects, removing previously displayed objects, and changing data structures associated with the electronic content, as examples.

The exemplary method 400 further involves incrementing the frame, time, or state of the electronic content, as shown in block 430. A content player may keep track of time and increment the current frame of time based on the passage of time. As another example, the state of a piece of electronic content may change as a result of receiving input from an end user, among other things. If the content is done, as determined at decision block 440, the method 400 ends. If the content continues, the method 400 returns to block 410 to determine changes again.

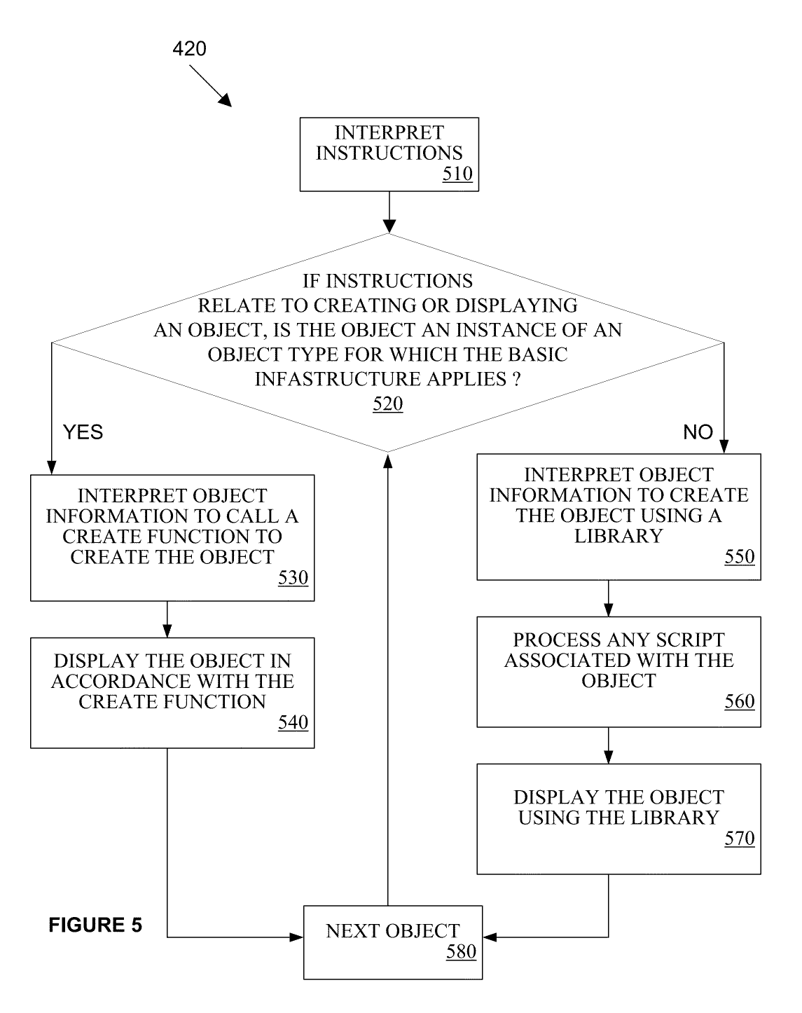

Determining changes for the current frame, time, or state of the electronic content as shown at block 420 of FIG. 4 can involve various steps. FIG. 5 provides an illustration of an exemplary method of determining such changes. This exemplary method 420 comprises interpreting instructions associated with the current frame, time, or state, as shown in block 510. If the instructions relate to creating or displaying an object, the method 420 involves determining if the object is an instance of an object type for which a basic (and presumably limited) infrastructure applies, as shown in block 520. This determination need not be explicit. For example, such a determination may be simply identifying an object type and determining how to create or display objects of that object type.

If the basic infrastructure applies, the exemplary method 420 interprets object information to call a create function to create the object, as shown in block 530, and displays the object in accordance with the create function, as shown in block 540. As an example, this may involve interpreting a tag-based instruction that specifies that an object of a given type is added on the current frame of an animation. The create function may be a part of the basic object infrastructure and applied to all instances where that tag-based instruction is used. Accordingly, the type of instruction may determine whether the basic infrastructure applies or not, i.e., if the instructions include an object of an object type that implicates the tag-based command, the object infrastructure applies, but if the instructions include an object of an object type that does not implicate that tag-based command, the object infrastructure may not apply. After displaying the object, the method 400 proceeds to block 480 to check the next object for changes at block 520.

Returning to block 520, if the object is not an instance of an object type for which the object infrastructure applies, the method 420 interprets the object's information to create the object, as shown in block 550. As also shown in block 550, this may involve accessing a library such as one that implements features for the particular object type. Unlike creation of an object using the call to the create function of the basic infrastructure, interpreting object information to create the object as performed by block 550 need not display the object.

Instead, as illustrated in blocks 560 and 570 the method proceeds to process some or all of the scripts associated with the created object, as shown in block 560, prior to proceeding to display the object, as shown in block 570. As also shown in block 570, displaying the object can involve accessing or otherwise using a library.

In one exemplary embodiment, objects of a text object type are provided with enhanced features. For example, two text boxes may be able to interact even though the boxes are not displayed simultaneously. Since the objects can be created prior to being displayed, they can both exist simultaneously at least in the memory associated with the playing content. This is beneficial, for example, to share text amongst text box objects that are not displayed simultaneously. A single text string may be displayed by both text box objects, where a portion of the text string displayed in one is determined while the electronic content is played and a remaining portion of the text string is displayed in the other. As another example, a text box object may interact with another object according to instructions in the electronic content such that text of the text object is positioned based on a boundary of the other object.

Text object types can utilize certain of the techniques disclosed herein in various ways. As an example, text flow data can be stored using a peer-to-peer method, where one of the script object instances (presumably the first) has all of the information. Each script object can point to a shared text flow which describes the text. Script object instances cooperate with one another to push the text flow information into one of the script object instances. When the information about the text flow initially comes, all the connections between the script object instances can be made specifying that the text flow is shared, identifying which instance has the information on the text flow, and setting up a shared text flow object.

In addition to these exemplary text features, the disclosed techniques can be used to support 3D, filters, blend modes, color transforms, pixel manipulation, and many other features.

One exemplary embodiment provides a script object infrastructure to support text and other features that involve objects that will be driven by script libraries rather than a more basic tag-based infrastructure connected to a library symbol. Instead of creating objects and putting them up for display with tags, such creation is done with automatically-generated script. A developer (i.e., an object type creator) can create a script library which implements certain APIs and drives the display and use of objects of that type during content creation and/or content play. A script object can be represented as a script object instance. When a script object is added, it will make a load request to get the library. Instructions, such as C++ code, can be used to extract the library specified and pass it back. A caching mechanism can be used to ensure that the same library is not reloaded repeatedly.

In one embodiment, a basic infrastructure “place object” command or tag is still used in creating an enhanced object. A placeholder may be placed by the “place object” tag and later replaced by the real object. This allows the enhanced object to be placed in the correct place in a display list maintained by the basic infrastructure, e.g., to maintain a correct z order, etc. The placeholder instance can have a different instance name than the final instance to avoid timing or other issues. The placeholder can be removed after the dynamic instance is created.

### General

Numerous specific details are set forth herein to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing platform, such as one or more computers or a similar electronic computing device or devices, that manipulate or transform data represented as physical electronic or magnetic quantities within memories, registers, or other information storage devices, transmission devices, or display devices of the computing platform.

The various systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software, that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

As noted above, a computing device may access one or more computer-readable media that tangibly embody computer-readable instructions which, when executed by at least one computer, cause the at least one computer to implement one or more embodiments of the present subject matter. When software is utilized, the software may comprise one or more components, processes, and/or applications. Additionally or alternatively to software, the computing device(s) may comprise circuitry that renders the device(s) operative to implement one or more of the methods of the present subject matter.

Examples of computing devices include, but are not limited to, servers, personal computers, personal digital assistants (PDAs), cellular telephones, televisions, television set-top boxes, and portable music players. Computing devices may be integrated into other devices, e.g. “smart” appliances, automobiles, kiosks, and the like.

The inherent flexibility of computer-based systems allows for a great variety of possible configurations, combinations, and divisions of tasks and functionality between and among components. For instance, processes discussed herein may be implemented using a single computing device or multiple computing devices working in combination. Databases and applications may be implemented on a single system or distributed across multiple systems. Distributed components may operate sequentially or in parallel.

When data is obtained or accessed as between a first and second computer system or components thereof, the actual data may travel between the systems directly or indirectly. For example, if a first computer accesses data from a second computer, the access may involve one or more intermediary computers, proxies, and the like. The actual data may move between the first and second computers, or the first computer may provide a pointer or metafile that the second computer uses to access the actual data from a computer other than the first computer, for instance. Data may be “pulled” via a request, or “pushed” without a request in various embodiments.

The technology referenced herein also makes reference to communicating data between components or systems. It should be appreciated that such communications may occur over any suitable number or type of networks or links, including, but not limited to, a dial-in network, a local area network (LAN), wide area network (WAN), public switched telephone network (PSTN), the Internet, an intranet or any combination of hard-wired and/or wireless communication links.

Any suitable tangible computer-readable medium or media may be used to implement or practice the presently-disclosed subject matter, including, but not limited to, diskettes, drives, magnetic-based storage media, optical storage media, including disks (including CD-ROMS, DVD-ROMS, and variants thereof), flash, RAM, ROM, and other memory devices.

1. A computer-implemented method comprising:
receiving one or more files comprising electronic content for playing on an electronic device, wherein the electronic device comprises a processor for processing instructions provided in the one or more files;
interpreting information about a first object to display the first object, the information about a first object calling a first create function to create the first object as an instance of the first object type and a first remove function to remove the first object, wherein the first create function and first remove function apply to instances of a plurality of object types and are limited such that creation does not occur without display and instances do not persist after display ends; and
interpreting information about a second object to display the second object, the information about the second object specifying the creation and removal of the second object as an instance of a second object type, wherein the second object type defines objects that are created without display and that persist after display ends; and
wherein a third object interacts with the second object when the second object is not displayed.

2. The method of claim 1 wherein the second object and the third object are text boxes, wherein the second object and the third object interact according to instructions in the electronic content.

3. The method of claim 2 wherein a single text string is displayed by the second object and the third object, wherein a portion of the text string displayed in the second object is determined while the electronic content is played and a remaining portion of the text string is displayed in the third object.

4. The method of claim 2 wherein the second object and the third object are displayed at different times during play of the electronic content and are not displayed simultaneously.

5. The method of claim 1 wherein the second object interacts with the third object according to instructions in the electronic content such that text of the second object is positioned based on a boundary of the third object.

6. The method of claim 1 further comprising receiving a library of additional instructions associated with the second object type and using those additional instructions to create, display, and remove the second object.

7. The method of claim 1 wherein the information about the first object is a plurality of tags and the information about the second object comprises script for creating the second object.

8. The method of claim 1 wherein any script associated with the first object is not available until after the first object is created and displayed.

9. A computer apparatus comprising:
a processor for processing instructions stored on the computer-readable medium to display electronic content;
a first component implemented by the processor processing instructions, wherein the first component interprets information about a first object to display the first object, the information about a first object calling a first create function to create the first object as an instance of the first object type, wherein the first create function applies to instances of a plurality of object types and is limited such that creation does not occur without display;
a library of additional instructions associated with a second object type;
a second component implemented by the processor processing instructions, wherein the second component interprets information about a second object to display the second object, the information about the second object specifying the creation and removal of the second object as an instance of the second object type, wherein the second object type defines objects that are created without display and that persist after display ends, wherein, when implemented by the processor, a third object interacts with the second object when the second object is not displayed.

10. The computer apparatus of claim 9 wherein the second object and the third object are text boxes, wherein the second component interprets instructions defining interaction between the second object and the third object.

11. The computer apparatus of claim 10 wherein the second component interprets instructions specifying that a portion of a text string to display in the second object and a remaining portion of the text string to display in the third object.

12. The computer apparatus of claim 10 wherein the second component interprets instructions specifying that the second object and the third object are displayed at different times during play of the electronic content and are not displayed simultaneously.

13. The computer apparatus of claim 9 wherein the second component interprets instructions specifying that the second object interacts with the third object according to instructions such that text of the second object is positioned based on a boundary of the third object.

14. The computer apparatus of claim 9 wherein the information about the first object is a plurality of tags and the information about the second object comprises script for creating the second object.

15. A non-transitory computer-readable medium on which is encoded program code, the program code comprising:
program code for receiving one or more files comprising electronic content for playing on an electronic device, wherein the electronic device comprises a processor for processing instructions provided in the one or more files;
program code for interpreting information about a first object to display the first object, the information about a first object calling a first create function to create the first object as an instance of the first object type and a first remove function to remove the first object, wherein the first create function and first remove function apply to instances of a plurality of object types and are limited such that creation does not occur without display and instances do not persist after display ends;
program code for interpreting information about a second object to display the second object, the information about the second object specifying the creation and removal of the second object as an instance of a second object type, wherein the second object type defines objects that are created without display and that persist after display ends, wherein, when the information about the second object is interpreted, a third object interacts with the second object when the second object is not displayed.

16. The computer-readable medium of claim 15 wherein the second object and the third object are text boxes, wherein the second object and the third object interact according to instructions in the electronic content, wherein a single text string is displayed by the second object and the third object, wherein a portion of the text string displayed in the second object is determined while the electronic content is played and a remaining portion of the text string is displayed in the third object.

17. The computer-readable medium of claim 15 wherein the second object and the third object are displayed at different times during play of the electronic content and are not displayed simultaneously.

18. The computer-readable medium of claim 15 wherein the second object interacts with the third object according to instructions in the electronic content such that text of the second object is positioned based on a boundary of the third object.

19. The computer-readable medium of claim 15 further comprising receiving a library of additional instructions associated with the second object type and using those additional instructions to create, display, and remove the second object.

20. The computer-readable medium of claim 15 wherein the information about the first object is a plurality of tags and the information about the second object comprises script for creating the second object.

21. The computer-readable medium of claim 15 wherein any script associated with the first object is not available until after the first object is created.

22. The computer implemented method of claim 1 wherein the electronic content for playing comprises instructions for animation and wherein the third object interacts with the second object according to the instructions for animation.

23. The computer implemented method of claim 1 wherein the third object interacts with the second object based on a current state of the second object.
